(19) United States
(12) Patent Application Publication
(10) Pub. No.: US 2007/0016580 A1
(43) Pub. Date: Jan. 18, 2007

(54) EXTRACTING INFORMATION ABOUT REFERENCES TO ENTITIES ROM A PLURALITY OF ELECTRONIC DOCUMENTS

(75) Inventors: John Kevin Mann, Richmond, CA (US); Tram Thi Mai Nguyen, San Jose, CA (US); Carlton Wayne Niblack, San Jose, CA (US); Zengyan Zhang, San Jose, CA (US)

Correspondence Address: INTERNATIONAL BUSINESS MACHINES CORPORATION;INTELLECTUAL PROPERTY LAW, 650 HARRY ROAD, SAN JOSE, CA, 95120, US

(73) Assignee: INTERNATIONAL BUSINESS MACHINES CORPORATION, Armonk, NY (US)

(21) Appl. No.: 11/160,943

(22) Filed: Jul. 15, 2005

(51) Int. Cl. G06F 17/30

(52) U.S. Cl. 707/6

(57) ABSTRACT

The present invention provides a method and system of extracting information about references to entities from a plurality of electronic documents. In an exemplary embodiment, the method and system include (1) applying at least one document quality measure to each of the plurality of electronic documents, (2) recognizing the references to entities in the plurality of electronic documents, (3) using at least one reference quality measure for each of the references to entities, (4) computing at least one topical category associated with each of the references to entities, (5) finding at least one co-occurring term associated with each of the references to entities, and (6) characterizing each of the references to entities by at least one characteristic category.

### FIELD OF THE INVENTION

The present invention relates to electronic documents, and particularly relates to a method and system of extracting information about references to entities from a plurality of electronic documents.

### BACKGROUND OF THE INVENTION

Extracting information about references to entities from a plurality of electronic documents is challenging. Extracting this information from a large collection of variable quality, time-varying, and unstructured or semi-structured electronic documents is very challenging.

Need for Information about References to Entities

There is a need for extracting categorized and trendable information about entities (e.g., companies, products, people) from various electronic sources such as Web pages, electronic news postings, blogs, and e-mail. Applications of this information include the early gauging of positive or negative public reaction to a product or company announcement, the discovery of new trends in public interests or opinions, and discovering unexpected relationships among entities.

An automated analysis of information in electronic documents is needed in order to answer several important business questions. For example, in terms of business strategy, there is a need to determine how the market is shifting over time and what a business' competitors are doing. In terms of marketing strategy, there is a need to ascertain how the market is segmented, who is interested in a particular product or topic, and what ideas and beliefs are associated with the product or topic. In terms of product design, there is a need to reveal what features that the consumers care about and what are the hot trends and needs. In terms of public relations, there is a need to find out what are the hot topics for media coverage and how is a company's product or service being properly covered and compared.

Furthermore, in terms of brand management, there is a need to determine how buyers and prospects see a company's offerings and what are a company's competitors doing. In terms of product management, there is a need to ascertain to what key trends and issues that consumers are responding and how is a company's product being perceived. In terms of advertising, there is a need to reveal where is a product strategy being discussed, whether a company's messages are making an impact, whether a company's advertising is hitting the company's target audience, whether there is an audience that a company's advertising has missed, and whether a company can see the results of its advertising. In terms of government affairs, there is a need to find out what legislative issues are active that concern a company, how is a company viewed by the government, and whether there are organizations that are active due to a company's products.

In addition, an automated analysis of information in electronic documents is needed in order to answer several higher level business questions about the information in the documents. For example, there is a need to determine the source of the information (i.e., Where is the information coming from?, Who said it?, Where was it said/printed/posted?). Also, there is a need to ascertain the reason for the information having been provided (i.e., Why?, Was there a particular unknown event that triggered a response?).

The following articles further describe the value of automated information extraction:

1. http://www.spectrum.ieee.org/WEBONLY/publicfeature/jan04/0104comp1.html;

2. http://www.infotoday.com/newsbreak/nb030922-1.shtml;

3. http://battellemedia.com/archives/000428.php;

4. http://radio.weblogs.com/0105910/2004/03/01.html; and

5. http://news.zdnet.com/2100-9584_{—}22-5153627.html.

Challenges in Extracting Information about References to Entities

Extracting information about references to entities from a plurality of electronic documents poses several challenges.

Variable Quality of Information

For example, information from the sources or sites of these documents (especially the Web) is of variable quality. Some sites are authoritative in that what the authoritative sites express is important and needs to be heavily weighted. Other sites are less important and less read and may contain unintentional or intentional duplicates or spam.

Categories of Information

In addition, information from the sources or sites of these documents often needs to be categorized and subcategorized by topic. For example, a given product may have thousands of valid citations on the Web. In order to be readily accessed and understood, the citations would need to be broken down into topical categories such as price, functionality, and quality. Also, references to a company would need to be broken down into products (e.g., one subcategory for each product), corporate governance, mergers, and legal actions.

Context of the Information

Also, in order to be useful for business and marketing purposes, references to entities in the form of Web citations often need to be categorized by the type of page or type of page context in which they appear. For example, it is useful to know if a Web reference to a company or product is from a product offering on an eCommerce site, a product evaluation, a news article, or an advertisement.

Age of the Information

In addition, information on the Web is from a wide range of dates. Many pages are old and stale. Current information is more valuable. Identifying the data that is up-to-date is essential for business use.

Volume of Information

Finally, the volume of available information is large and continually changing. Therefore, extracting information about references to entities from a plurality of electronic documents would need to be automated. Manual training, setup, and refinement may be used, but regular, repeated processing must be automatic, requiring no manual intervention. The large volume of new and unstructured electronic documents being produced via computer systems demands an automated approach. Credible estimates of global information production (in the form of electronic documents) commonly conclude that the production of accessible electronic information in electronic documents now far outstrips manual methods of reading and tracking the information in the documents. For example, the Internet provides access to over 8 billion pages, or electronic documents, of information, and an estimated 50+ million new pages of information daily. Also, some news and trade journal services provide access to approximately 100,000 new electronic documents every week. Such services provide access not only to official or corporate sources but also to personal on-line journals (i.e., blogs), personal web pages on the Web, and on-line discussion forums. As a result, accessible electronic information now reflects social and political trends, consumer interests, reactions to products, and company reputation. In addition, since many consumers use the Internet doing product research, the information on the Internet becomes, for some consumers, the most influential source of product information, regardless of the accuracy of the information.

Prior Art Systems

Currently, prior art methods and systems of extracting information about references to entities from a plurality of electronic documents fail to address this need and fail to meet these challenges. Several prior art systems include systems offered by Intelliseek, Inc. (Please see http://www.intelliseek.com.) and ClearForest Corporation (Please see http://www.clearforest.com.). In a first prior art system, as shown in prior art FIG. 1, first prior art extracting system (a) collects documents, (b) annotates the documents to identify entities, (c) summarizes information, and (d) extracts information (Please see http://www.intelliseek.com.). However, the first prior art system is optimized to address marketing domain questions. In addition, the first prior art system is capable of handling a limited set of documents and a limited set of annotations.

Therefore, a method and system of extracting information about references to entities from a plurality of electronic documents is needed.

### SUMMARY OF THE INVENTION

The present invention provides a method and system of extracting information about references to entities from a plurality of electronic documents. In an exemplary embodiment, the method and system include (1) applying at least one document quality measure to each of the plurality of electronic documents, (2) recognizing the references to entities in the plurality of electronic documents, (3) using at least one reference quality measure for each of the references to entities, (4) computing at least one topical category associated with each of the references to entities, (5) finding at least one co-occurring term associated with each of the references to entities, and (6) characterizing each of the references to entities by at least one characteristic category.

In an exemplary embodiment, the applying includes assigning at least one quality score to each of the plurality of electronic documents. In a specific embodiment, the assigning includes assigning the quality score based on the source of the electronic document. In a specific embodiment, the assigning includes assigning the quality score based on the amount of text in the electronic document. In a specific embodiment, the assigning includes assigning the quality score based on whether the electronic document is a duplicate of other electronic documents in the plurality of electronic documents. In a specific embodiment, the assigning includes assigning the quality score based on whether the electronic document is a near duplicate of other electronic documents in the plurality of electronic documents. In a specific embodiment, the assigning includes assigning the quality score based on whether the electronic document contains unwanted text.

In a specific embodiment, the assigning includes assigning the quality score based on the rank of the electronic document, where the rank is selected from the group consisting of pagerank, hostrank, and eyeball count. In a further embodiment, the assigning includes, if the quality score of the electronic document is less than a threshold, eliminating the electronic document.

In an exemplary embodiment, the recognizing includes identifying candidate references to entities in the plurality of electronic documents from a set of entity names. In a specific embodiment, the identifying includes identifying the candidate references to entities by an identifying technique, wherein the identifying technique is selected from the group consisting of direct spotting, index-based retrieval, and named entity recognition. In a further embodiment, the identifying further includes disambiguating the candidate references to entities, thereby identifying the references to entities.

In an exemplary embodiment, the using includes assigning at least one quality score to each of the references to entities. In a specific embodiment, the assigning includes assigning the quality score based on whether the snippet of text in which the reference to entities occurs is unique. In a specific embodiment, the assigning includes assigning the quality score based on the running text quality of the reference to entities. In a specific embodiment, the assigning includes assigning the quality score based on whether the snippet of text in which the reference to entities occurs can be parsed by natural language parsing to yield a subject and a verb. In a specific embodiment, the assigning includes assigning the quality score based on whether the snippet of text in which the reference to entities occurs can be parsed by natural language parsing to yield a valid sentence. In a specific embodiment, the assigning includes assigning the quality score based on whether the snippet of text in which the reference to entities occurs satisfies a set of heuristic rules based on the textual properties of the snippet.

In a specific embodiment, the assigning includes assigning the quality score based on the document markup properties of the snippet of text in which the reference to entities occurs. In a specific embodiment, the assigning includes assigning the quality score based on whether the snippet of text in which the reference to entities occurs comprises content text. In a further embodiment, the assigning further includes, if the quality score of the reference to entities is less than a threshold, eliminating the reference to entities.

In an exemplary embodiment, the computing includes identifying specified words and phrases that co-occur with the references to entities. In an exemplary embodiment, the finding includes finding unspecified words or phrases that co-occur with the references to entities.

In an exemplary embodiment, the characterizing includes assigning at least one characteristic to each of the references to entities. In a specific embodiment, the assigning includes assigning the date of the electronic document in which the reference to entities occurs as the characteristic. In a specific embodiment, the assigning includes assigning the source type of the electronic document in which the reference to entities occurs as the characteristic. In a specific embodiment, the assigning includes assigning the geographic location associated with the electronic document in which the reference to entities occurs as the characteristic.

In a specific embodiment, the assigning includes assigning the language of the snippet of text in which the reference to entities occurs as the characteristic. In a specific embodiment, the assigning includes assigning the sentiment of the snippet of text in which the reference to entities occurs as the characteristic. In a specific embodiment, the assigning includes assigning the author of the snippet of text in which the reference to entities occurs as the characteristic. In a specific embodiment, the assigning includes assigning the rank of the electronic document in which the reference to entities occurs as the characteristic, where the rank is selected from the group consisting of pagerank, hostrank, and eyeball count.

In a further embodiment, the method and system further include storing the extracted information about the references to entities. In a further embodiment, the method and system further include allowing for the input of feedback on the extracting.

The present invention also provides a computer program product usable with a programmable computer having readable program code embodied therein of extracting information about references to entities from a plurality of electronic documents. In an exemplary embodiment, the computer program product includes (1) computer readable code for applying at least one document quality measure to each of the plurality of electronic documents, (2) computer readable code for recognizing the references to entities in the plurality of electronic documents, (3) computer readable code for using at least one reference quality measure for each of the references to entities, (4) computer readable code for computing at least one topical category associated with each of the references to entities, (5) computer readable code for finding at least one co-occurring term associated with each of the references to entities, and (6) computer readable code for characterizing each of the references to entities by at least one characteristic category.

### THE FIGURES

FIG. 1 is a flowchart of a prior art technique.

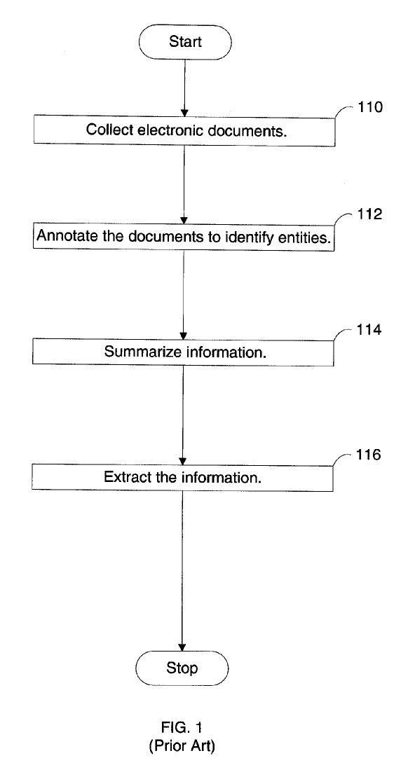

FIG. 2 is a flowchart in accordance with an exemplary embodiment of the present invention.

FIG. 3A is a flowchart of the applying step in accordance with an exemplary embodiment of the present invention.

FIG. 3B is a flowchart of the applying step in accordance with a specific embodiment of the present invention.

FIG. 3C is a flowchart of the applying step in accordance with a specific embodiment of the present invention.

FIG. 3D is a flowchart of the applying step in accordance with a specific embodiment of the present invention.

FIG. 3E is a flowchart of the applying step in accordance with a specific embodiment of the present invention.

FIG. 3F is a flowchart of the applying step in accordance with a specific embodiment of the present invention.

FIG. 3G is a flowchart of the applying step in accordance with a specific embodiment of the present invention.

FIG. 3H is a flowchart of the applying step in accordance with a further embodiment of the present invention.

FIG. 4A is a flowchart of the recognizing step in accordance with an exemplary embodiment of the present invention.

FIG. 4B is a flowchart of the recognizing step in accordance with a specific embodiment of the present invention.

FIG. 4C is a flowchart of the recognizing step in accordance with a further embodiment of the present invention.

FIG. 5A is a flowchart of the using step in accordance with an exemplary embodiment of the present invention.

FIG. 5B is a flowchart of the using step in accordance with a specific embodiment of the present invention.

FIG. 5C is a flowchart of the using step in accordance with a specific embodiment of the present invention.

FIG. 5D is a flowchart of the using step in accordance with a particular embodiment of the present invention.

FIG. 5E is a flowchart of the using step in accordance with a particular embodiment of the present invention.

FIG. 5F is a flowchart of the using step in accordance with a particular embodiment of the present invention.

FIG. 5G is a flowchart of the using step in accordance with a specific embodiment of the present invention.

FIG. 5H is a flowchart of the using step in accordance with a specific embodiment of the present invention.

FIG. 5I is a flowchart of the using step in accordance with a further embodiment of the present invention.

FIG. 6 is a flowchart of the computing step in accordance with an exemplary embodiment of the present invention.

FIG. 7 is a flowchart of the finding step in accordance with an exemplary embodiment of the present invention.

FIG. 8A is a flowchart of the characterizing step in accordance with an exemplary embodiment of the present invention.

FIG. 8B is a flowchart of the characterizing step in accordance with a specific embodiment of the present invention.

FIG. 8C is a flowchart of the characterizing step in accordance with a specific embodiment of the present invention.

FIG. 8D is a flowchart of the characterizing step in accordance with a specific embodiment of the present invention.

FIG. 8E is a flowchart of the characterizing step in accordance with a specific embodiment of the present invention.

FIG. 8F is a flowchart of the characterizing step in accordance with a specific embodiment of the present invention.

FIG. 8G is a flowchart of the characterizing step in accordance with a specific embodiment of the present invention.

FIG. 8H is a flowchart of the characterizing step in accordance with a specific embodiment of the present invention.

FIG. 9 is a flowchart of the storing step in accordance with a further embodiment of the present invention.

FIG. 10 is a flowchart of the allowing step in accordance with a further embodiment of the present invention.

### DETAILED DESCRIPTION OF THE INVENTION

The present invention provides a method and system of extracting information about references to entities from a plurality of electronic documents. In an exemplary embodiment, the method and system include (1) applying at least one document quality measure to each of the plurality of electronic documents, (2) recognizing the references to entities in the plurality of electronic documents, (3) using at least one reference quality measure for each of the references to entities, (4) computing at least one topical category associated with each of the references to entities, (5) finding at least one co-occurring term associated with each of the references to entities, and (6) characterizing each of the references to entities by at least one characteristic category. In an exemplary embodiment, the plurality of electronic documents are provided from (a) a regular, repeated feed of documents such as a Web crawl (i.e., fetching) that provides Web pages and/or (b) a similar data ingestion from bulletin board postings, blog postings, news feeds, and/ore-mail.

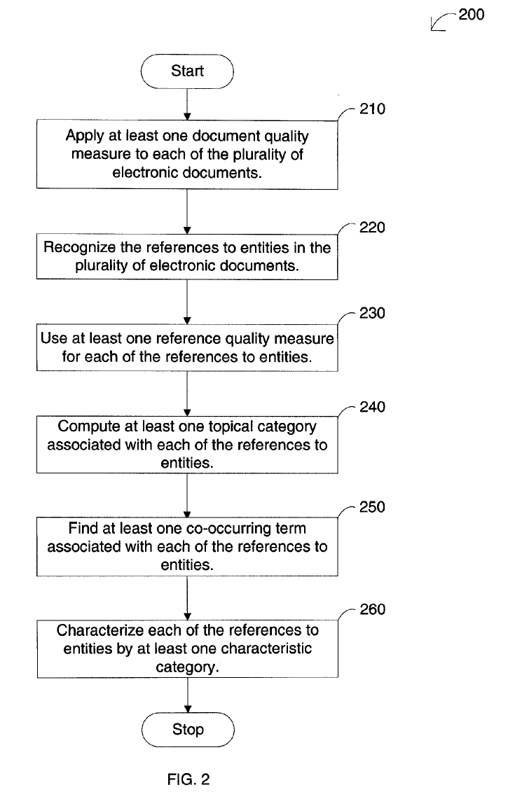

Referring to FIG. 2, in an exemplary embodiment, the present invention includes a step 210 of applying at least one document quality measure to each of the plurality of electronic documents, a step 220 of recognizing the references to entities in the plurality of electronic documents, a step 230 of using at least one reference quality measure for each of the references to entities, a step 240 of computing at least one topical category associated with each of the references to entities, a step 250 of finding at least one co-occurring term associated with each of the references to entities, and a step 260 of characterizing each of the references to entities by at least one characteristic category.

Applying Document Quality Measures

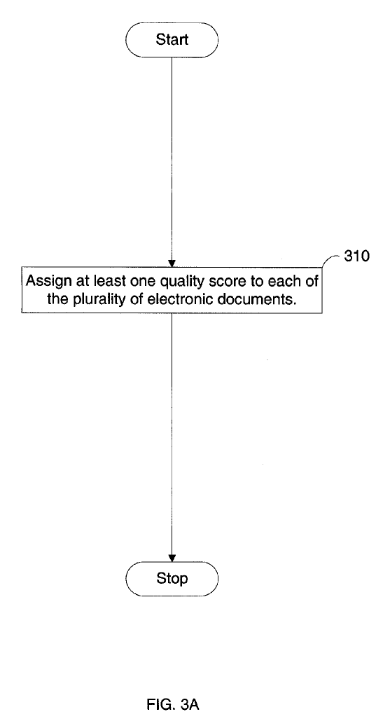

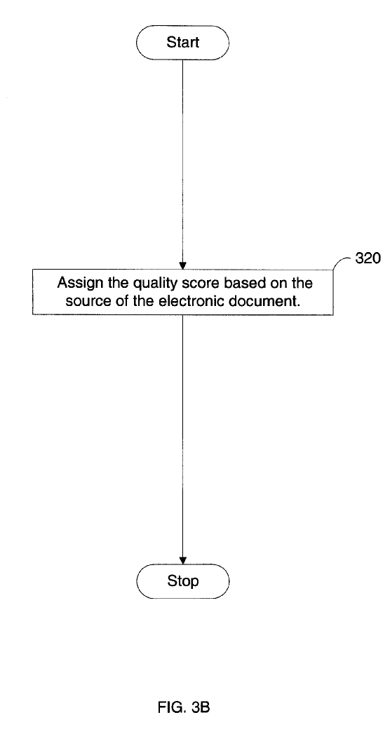

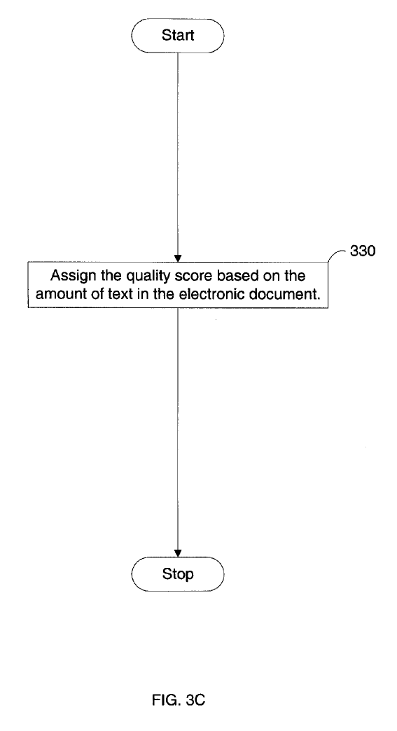

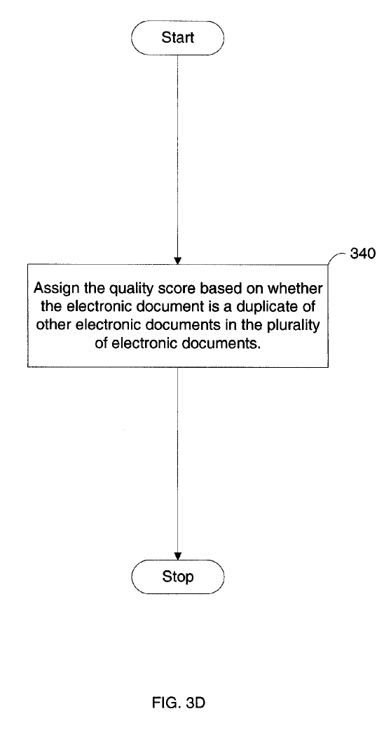

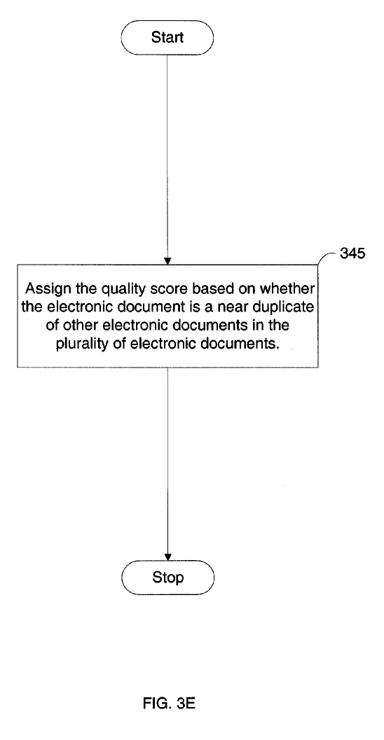

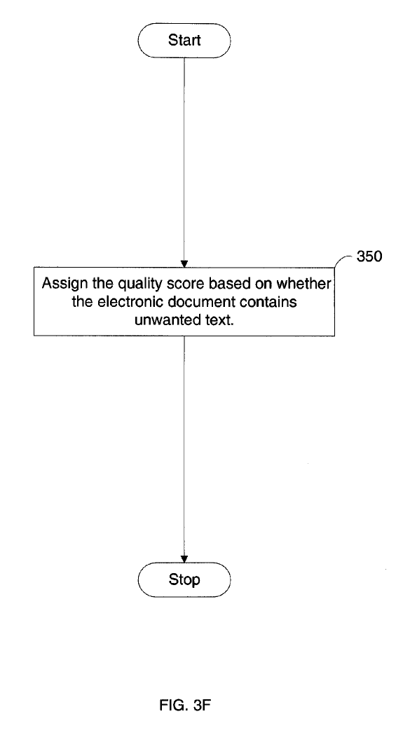

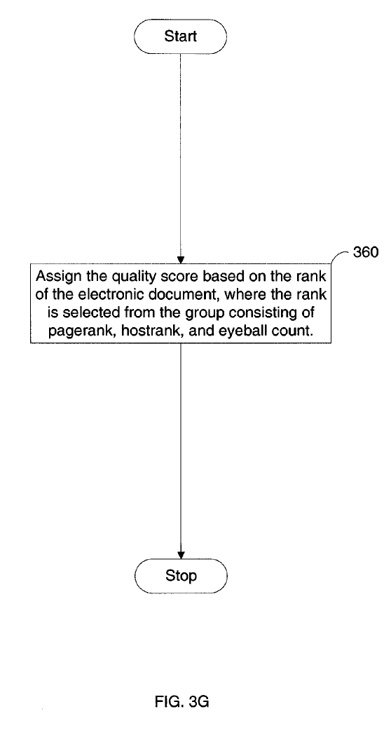

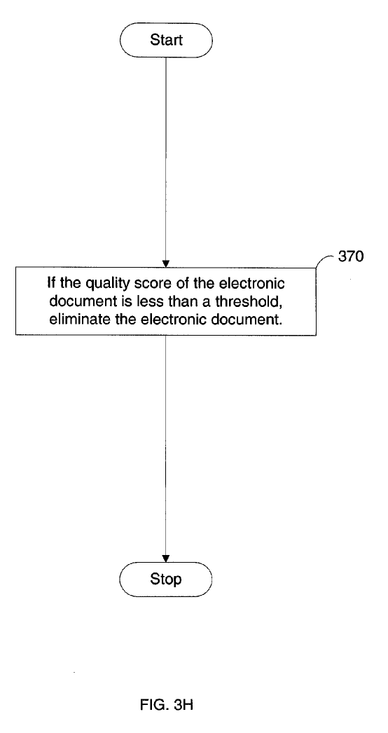

Referring to FIG. 3A, in an exemplary embodiment, applying step 210 includes a step 310 of assigning at least one quality score to each of the plurality of electronic documents. Referring next to FIG. 3B, in a specific embodiment, assigning step 310 includes a step 320 of assigning the quality score based on the source of the electronic document. For example, assigning step 320 may assign the quality score based on whether the electronic document is (a) a Web page from a known spamming or pornography site, (b) an e-mail from a list of known spam sources, or (c) a Web page from an uninteresting site. Referring next to FIG. 3C, in a specific embodiment, assigning step 310 includes a step 330 of assigning the quality score based on the amount of text in the electronic document.

Referring next to FIG. 3D, in a specific embodiment, assigning step 310 includes a step 340 of assigning the quality score based on whether the electronic document is a duplicate of other electronic documents in the plurality of electronic documents. In a specific embodiment, assigning step 340 is performed as described in A. Broder, S. Glassman, M. Manasse, Syntactic Clustering of the Web, WWW6, 1997. For Web pages, duplicates may occur both within and across the sites. Referring next to FIG. 3E, in a specific embodiment, assigning step 310 includes a step 345 of assigning the quality score based on whether the electronic document is a near duplicate of other electronic documents in the plurality of electronic documents. In a specific embodiment, assigning step 345 is performed as described in A. Broder, S. Glassman, M. Manasse, Syntactic Clustering of the Web, WWW6, 1997. For Web pages, near duplicates may occur both within and across the sites.

Referring next to FIG. 3F, in a specific embodiment, assigning step 310 includes a step 350 of assigning the quality score based on whether the electronic document contains unwanted text (e.g., pornography). In a specific embodiment, assigning step 350 is performed by standard classification algorithms (e.g., naïve Bayesian classification) trained to identify the unwanted text (e.g., Duda and Hart, Pattern Classification and Scene Analysis).

Referring next to FIG. 3G, in a specific embodiment, assigning step 310 includes a step 360 of assigning the quality score based on the rank of the electronic document, where the rank is selected from the group consisting of pagerank, hostrank, and eyeball count. In a specific embodiment, assigning step 310 includes assigning the quality score based on the pagerank of the electronic document. In a specific embodiment, the assigning is performed as described in S. Brin, L. Page, The Anatomy of a Large Scale Hypertext Web Search Engine, WWW7. In a specific embodiment, assigning step 310 includes assigning the quality score based on the hostrank of the electronic document. In a specific embodiment, the assigning is performed as described in U.S. patent application Ser. No. 10/847,143, filed May 15, 2004. In a specific embodiment, assigning step 310 includes assigning the quality score based on the eyeball count of the electronic document. In a specific embodiment, the assigning is performed by (a) using data provided by commercially available sources (e.g., Nielsen/NetRatings as described in http://www.netratings.com) and (b) assigning a default value when no eyeball count data is available (e.g., when commercial eyeball count data does not have complete coverage for all web pages).

Referring next to FIG. 3H, in a further embodiment, assigning step 310 further includes a step 370 of, if the quality score of the electronic document is less than a threshold, eliminating the electronic document. In a further embodiment, assigning step 310 further includes, if at least one quality score of the electronic document is less than a threshold, eliminating the electronic document. In a further embodiment, assigning step 310 further includes, if the quality score of the electronic document is less than a threshold, tagging the electronic document with the quality score. In a specific embodiment, the tagging using the quality score to control the further processing of the electronic document. In an exemplary embodiment, the further processing includes at least any of the following:

1. displaying the electronic document;

2. querying on the electronic document;

3. summarizing the electronic document;

4. performing business analysis on the electronic document;

5. ranking the electronic document;

6. generating trends regarding the electronic document;

7. displaying the trends;

8. alerting regarding the electronic document;

9. counting the electronic document; and

10. allowing further querying (i.e., drill down) on the electronic document.

Recognizing References to Entities

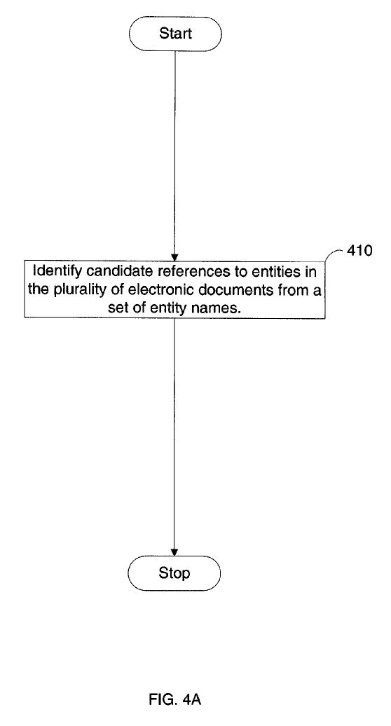

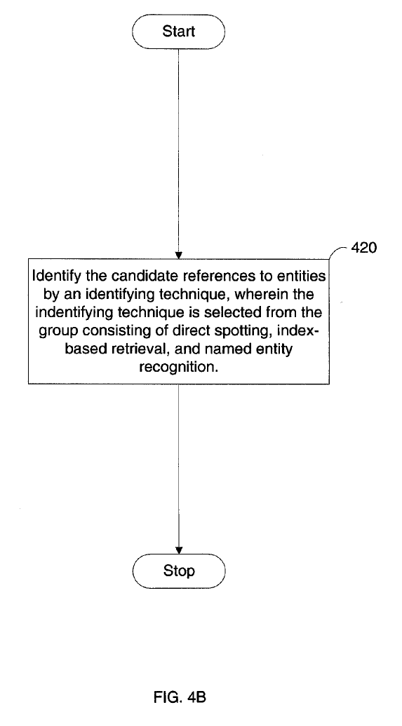

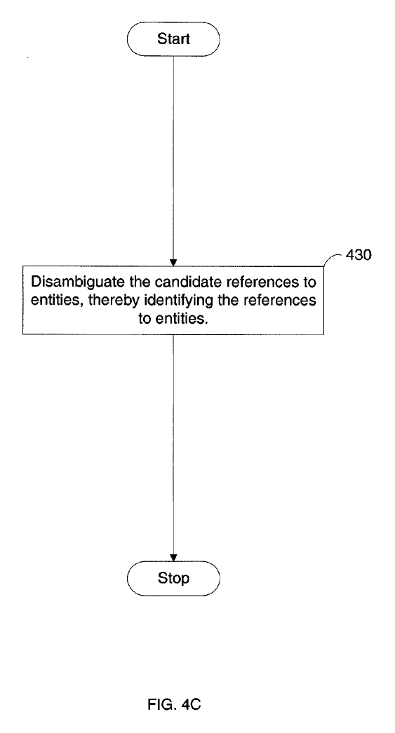

Referring to FIG. 4A, in an exemplary embodiment, recognizing step 220 includes a step 410 of identifying candidate references to entities in the plurality of electronic documents from a set of entity names. In a specific embodiment, the set of entity names includes a set of names as well as aliases, alternate spellings, and abbreviations (e.g., “Robert Smith”, “Bob Smith”, and “R. Smith”). In a specific embodiment, identifying step 410 merges or collapses references to entities using a table of common abbreviations (e.g., “Int'l” is equivalent to “International”, “Dept” is equivalent to “Department”), plurals, and possessives.

Referring next to FIG. 4B, in a specific embodiment, identifying step 410 includes a step 420 of identifying the candidate references to entities by an identifying technique, wherein the identifying technique is selected from the group consisting of direct spotting, index-based retrieval, and named entity recognition. In a specific embodiment, identifying step 410 includes identifying the candidate references to entities by direct spotting. In a specific embodiment, identifying step 410 includes identifying the candidate references to entities by index-based retrieval. In a specific embodiment, identifying step 410 includes identifying the candidate references to entities by named entity recognition. In a specific embodiment, the identifying is performed as described in Tong Zhang and David Johnson, Robust Risk Minimization based Named Entity Recognition System, CoNLL-2003, pages 204-207. In addition, the identifying clusters the references to generate an abstract entity. In a specific embodiment, the identifying performs the clustering by applying standard clustering algorithms such as k-means to the term/phrase co-occurrence matrix.

Referring next to FIG. 4C, in a further embodiment, identifying step 410 further includes a step 430 of disambiguating the candidate references to entities, thereby identifying the references to entities. In a specific embodiment, disambiguating step 430 includes discarding instances of the candidate references to entities that are off-topic. For example, the candidate reference to entities “Sun” might refer to a company in the computer industry, or to the solar body. In an exemplary embodiment, disambiguating step 430 uses on-topic and off-topic terms that are given together with the set of entity names. In a specific embodiment, disambiguating step 430 is performed as described in R. Nelken, E. Amitay, A. Soffer, D. C. Smith, and W. Niblack, Disambiguation for Text Mining on the Web, WWW2003.

Using Reference Quality Measures

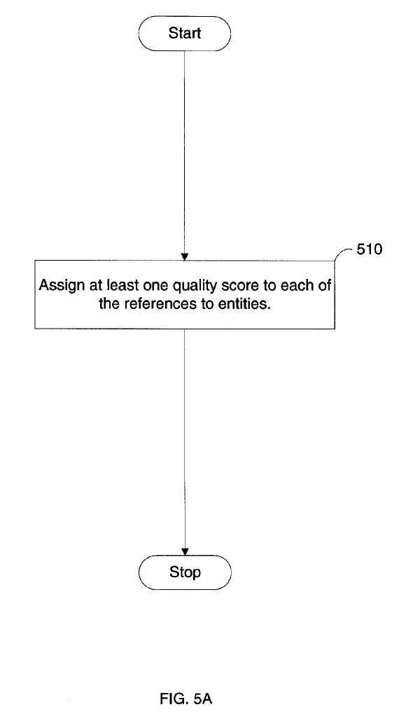

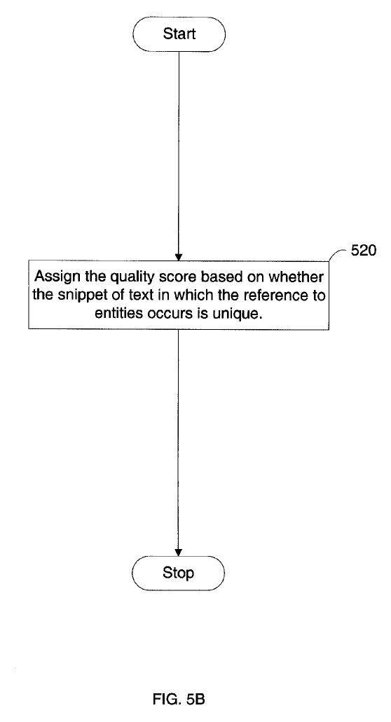

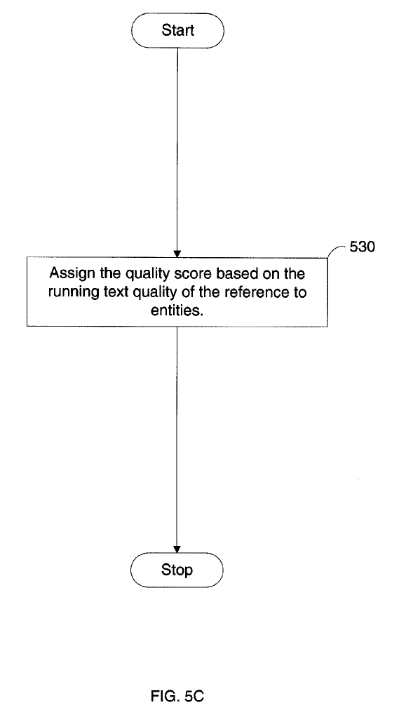

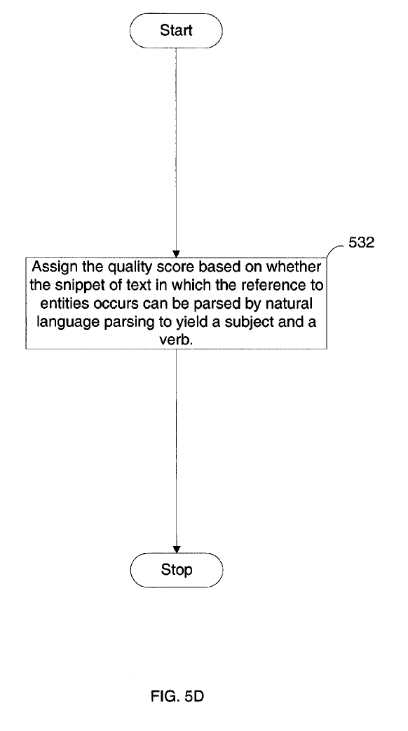

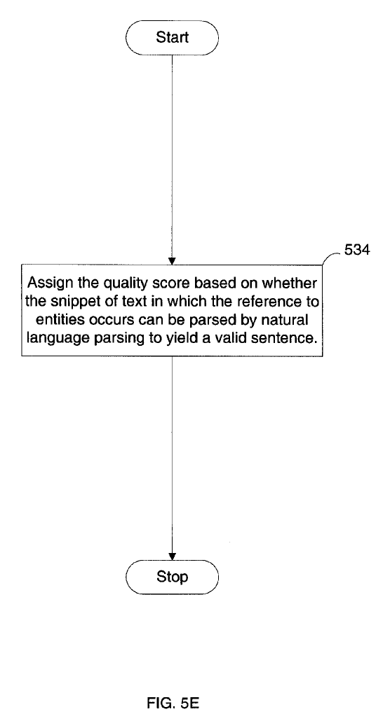

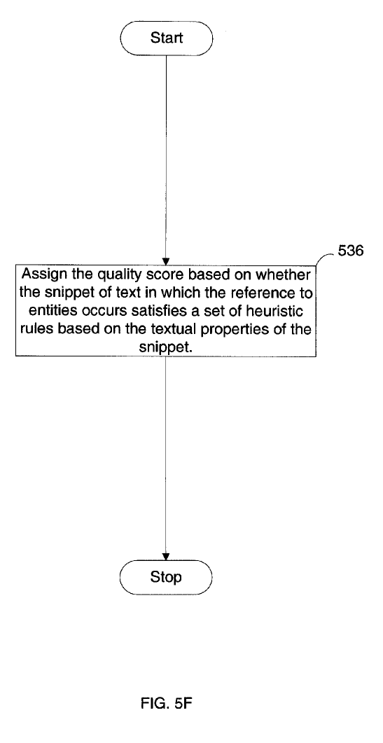

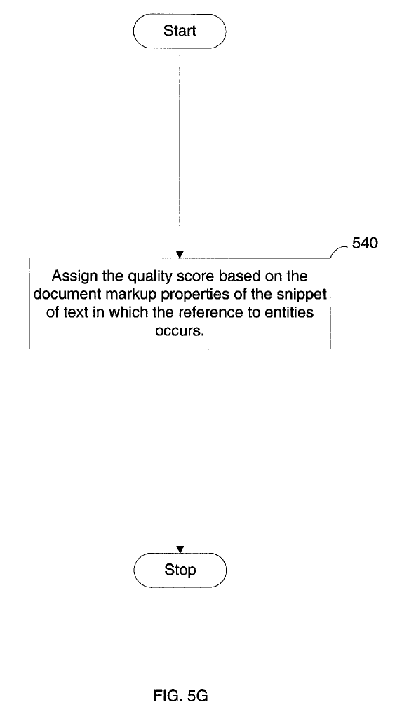

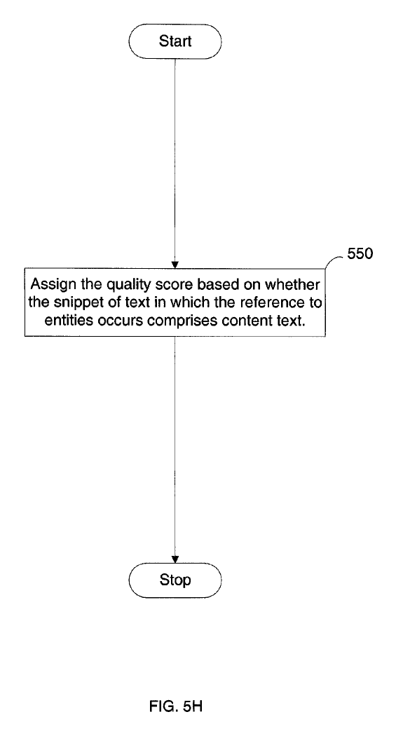

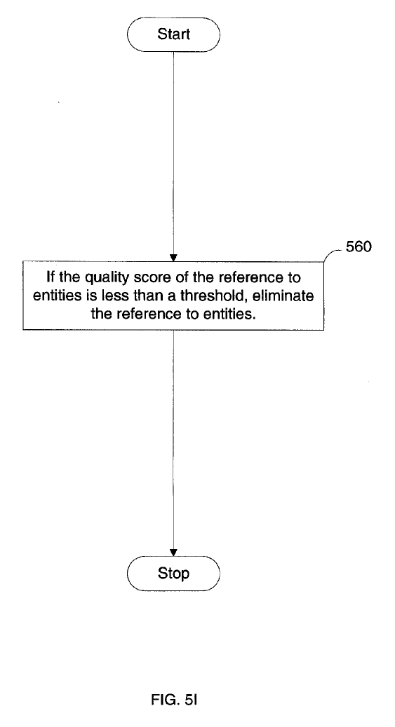

Referring to FIG. 5A, in an exemplary embodiment, using step 230 includes a step 510 of assigning at least one quality score to each of the references to entities. Referring next to FIG. 5B, in a specific embodiment, assigning step 510 includes a step 520 of assigning the quality score based on whether the snippet of text in which the reference to entities occurs is unique. In a specific embodiment, assigning step 520 includes computing a fingerprint of the snippet (e.g., the MD5 (Message Digest 5 algorithm) hash of the snippet) such that (a) snippets with the same MD5 hash are tagged as duplicates and (b) one of the snippets is identified as unique. In an alternative embodiment, assigning step 520 includes using a shingle-based method.

Referring next to FIG. 5C, in a specific embodiment, assigning step 510 includes a step 530 of assigning the quality score based on the running text quality of the reference to entities. Referring next to FIG. 5D, in a particular embodiment, assigning step 530 includes a step 532 of assigning the quality score based on whether the snippet of text in which the reference to entities occurs can be parsed by natural language parsing to yield a subject and a verb. Referring next to FIG. 5E, in a particular embodiment, assigning step 530 includes a step 534 of assigning the quality score based on whether the snippet of text in which the reference to entities occurs can be parsed by natural language parsing to yield a valid sentence. Referring next to FIG. 5F, in a particular embodiment, assigning step 530 includes a step 536 of assigning the quality score based on whether the snippet of text in which the reference to entities occurs satisfies a set of heuristic rules based on the textual properties of the snippet. In a specific embodiment, the set of heuristic rules relate to capitalization, punctuation, overall length, and other text properties. Such heuristic methods may identify Web page lists, menu pull-downs, keyword spamming, and other low quality instances.

Referring next to FIG. 5G, in a specific embodiment, assigning step 510 includes a step 540 of assigning the quality score based on the document markup properties of the snippet of text in which the reference to entities occurs. In a specific embodiment, assigning step 540 assigns Web text in tags (e.g., title, h1) a higher quality measure and assigns e-mail content in a Subject field a higher quality measure.

Referring next to FIG. 5H, in a specific embodiment, assigning step 510 includes a step 550 of assigning the quality score based on whether the snippet of text in which the reference to entities occurs comprises content text. In a specific embodiment, assigning step 550 is performed as described in L. Yi, B. Liu, X. Li, Eliminating Noisy Information in Web Pages for Data Mining, SIGKDD 03. In another embodiment, assigning step 550 is performed as described in Barjossef, Z. and Rajagopalan, S., Template Detection via Data Mining and Its Applications, WWW 2002. In a further embodiment, assigning step 550 further includes assigning the quality score based on whether the snippet of text in which the reference to entities occurs comprises template text. Template text is the opposite of content text. Thus, assigning step 550 assigning the quality score based on whether the snippet of text in which the reference to entities occurs comprises content text or template text. Template text includes templates (text that appears on multiple pages), header and footer information for certain document types, boilerplate, navigation text for web pages, copyright notices, and “Best Viewed with . . . .” notices. For e-mail, template text includes SMTP headers, advertisements inserted by web-based e-mail programs, standard usage condition notices, unsubscribe notices, and similar content.

Referring next to FIG. 51, in a further embodiment, assigning step 510 further includes a step 560 of, if the quality score of the reference to entities is less than a threshold, eliminating the reference to entities. In a further embodiment, assigning step 510 further includes, if at least one quality score of the reference to entities is less than a threshold, eliminating the reference to entities. In a further embodiment, assigning step 510 further includes, if the quality score of the reference to entities is less than a threshold, tagging the reference to entities with the quality score. In a specific embodiment, tagging step 570 includes using the quality score to control the further processing of the reference to entities. In an exemplary embodiment, the further processing includes at least any of the following:

1. displaying the electronic document;

2. querying on the electronic document;

3. summarizing the electronic document;

4. performing business analysis on the electronic document;

5. ranking the electronic document;

6. generating trends regarding the electronic document;

7. displaying the trends;

8. alerting regarding the electronic document;

9. counting the electronic document; and

10. allowing further querying (i.e., drill down) on the electronic document.

Computing Topical Categories

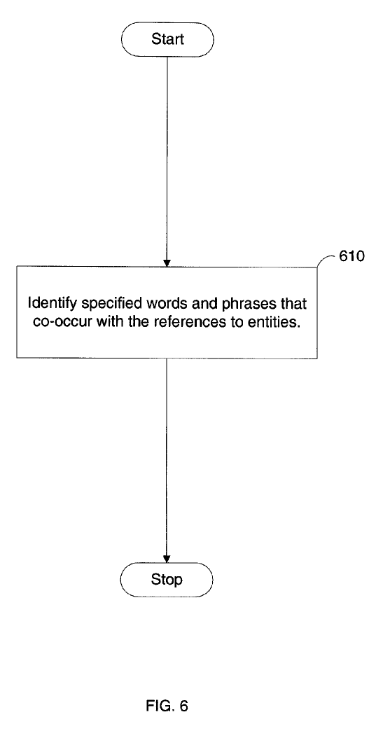

Referring to FIG. 6, in an exemplary embodiment, computing step 240 includes a step 610 of identifying specified words and phrases that co-occur with the references to entities. In a specific embodiment, identifying step 610 identifies the specified words and phrases from at least one topical taxonomy. For example, a taxonomy may include terms related to corporate governance, product quality, and customer relations. In a specific embodiment, identifying step 610 looks in a snippet of text in which each reference to entities occurs for all occurrences of words or phrases from the taxonomies. In a specific embodiment, identifying step 610 maintains in a data structure a list of each entity, each occurrence of that entity in the input documents, and a list of each occurrence of terms or phrases from the topical taxonomies in the snippets.

Finding Co-Occurring Terms

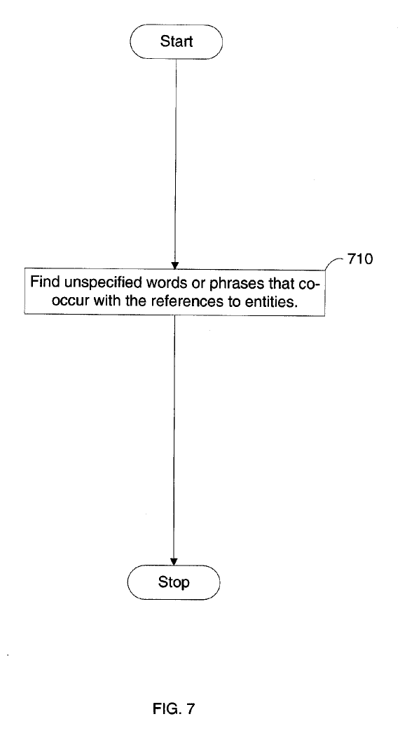

Referring to FIG. 7, in an exemplary embodiment, finding step 250 includes a step 710 of finding unspecified words or phrases that co-occur with the references to entities. In a specific embodiment, finding step 710 is performed as described in Patrick Pantel and Dekang Lin, A Statistical Corpus-based Term Extractor, Proceedings of the 14th Biennial Conference of the Canadian Society on Computational Studies of Intelligence: Advances in Artificial Intelligence, pp 36-46, 2001. In a specific embodiment, finding step 710 combines synonyms and different forms of the on-topic references to entities by using WordNet (described at http://www.cogsci.princeton.edu/˜wn), which includes lists of synonyms and stemming information. In an specific embodiment, finding step 710 forms a co-occurrence matrix and applies clustering in order (a) to group the terms together and (b) to form the issues or topics associated with the references to entities. In a specific embodiment, finding step 710 categorizes the terms or words or phrases under the discovered issues or topics.

Characterizing References to Entities

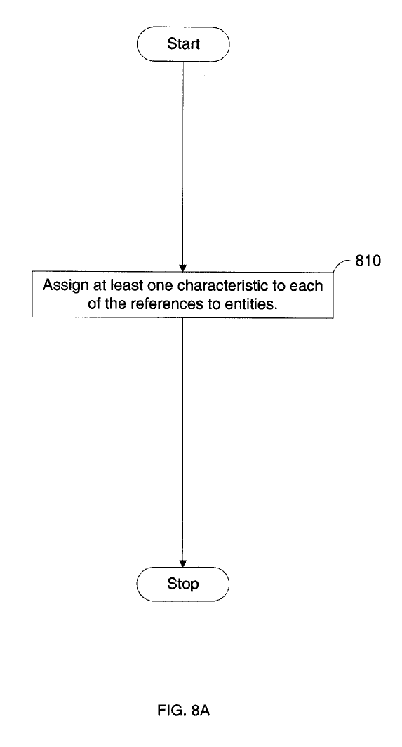

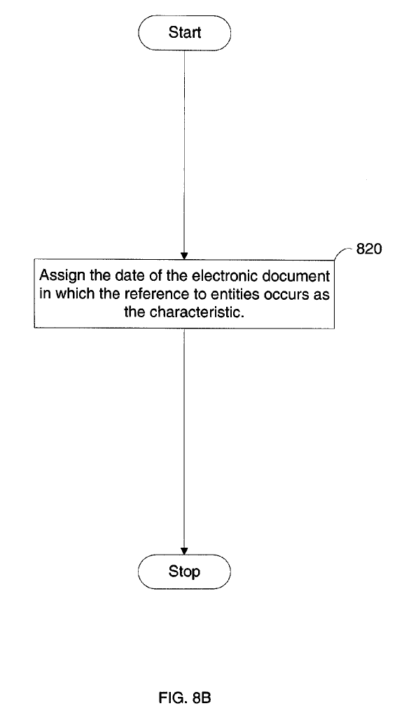

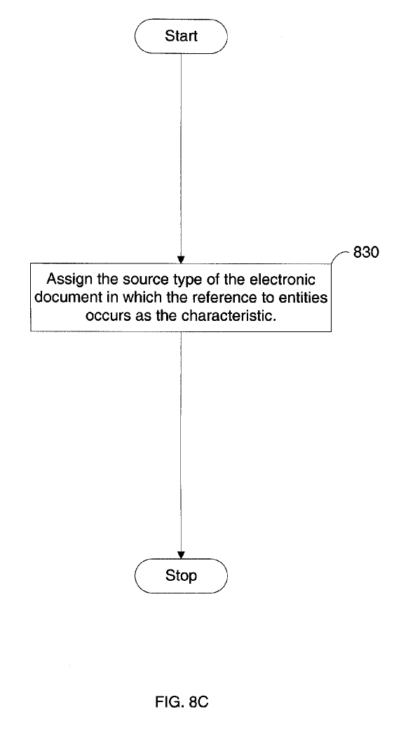

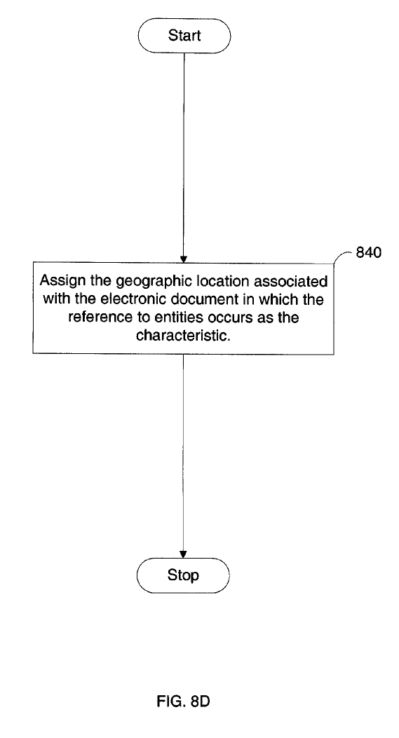

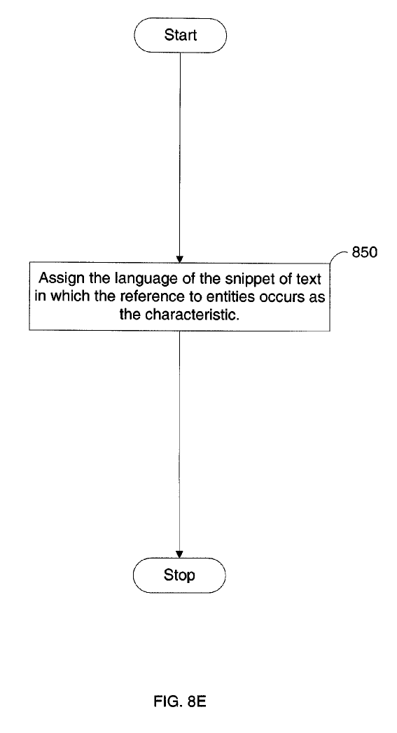

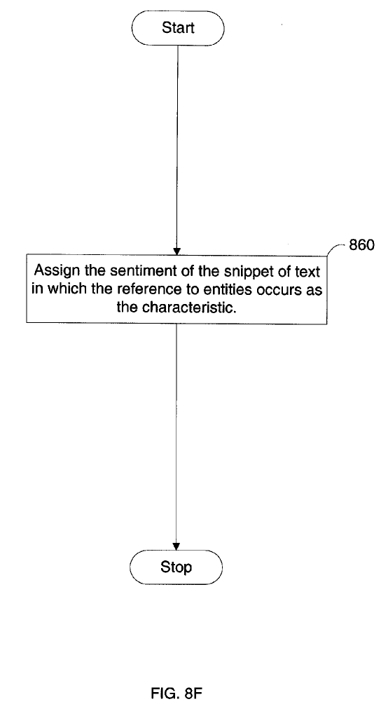

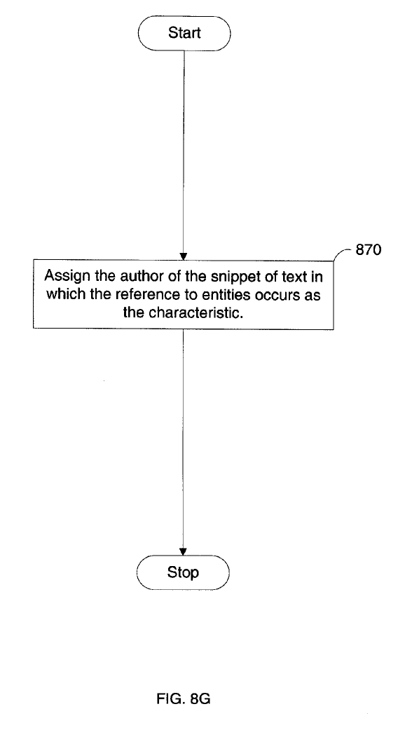

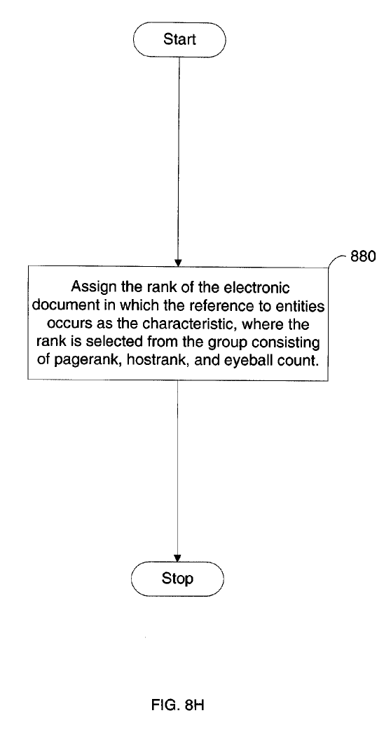

Referring to FIG. 8A, in an exemplary embodiment, characterizing step 260 includes a step 810 of assigning at least one characteristic to each of the references to entities. Referring next to FIG. 8B, in a specific embodiment, assigning step 810 includes a step 820 of assigning the date of the electronic document in which the reference to entities occurs as the characteristic. In a specific embodiment, assigning step 820 includes parsing dates from the document identifier (Uniform Resource Locator (URL) for Web pages), textual content, or available metadata of the electronic document. In a specific embodiment, assigning step 820 use the technique described in U.S. patent application Ser. No. 10/908,215, filed May 2, 2005. In a specific embodiment, assigning step 810 includes assigning the date of the portion of the electronic document in which the reference to entities occurs as the characteristic. In a specific embodiment, the assigning includes parsing dates from the textual content of the electronic document. In a specific embodiment, the assigning uses the technique described in U.S. patent application Ser. No. 10/908,215, filed May 2, 2005.

Referring next to FIG. 8C, in a specific embodiment, assigning step 810 includes a step 830 of assigning the source type of the electronic document in which the reference to entities occurs as the characteristic. In a specific embodiment, the source type is predefined. For example, a source type may be “all documents from this list of websites are considered ‘major media’”. In a specific embodiment, the source type is defined by automated classification. Exemplary source types are blogs, news postings, industry Web pages, and e-mail.

Referring next to FIG. 8D, in a specific embodiment, assigning step 810 includes a step 840 of assigning the geographic location associated with the electronic document in which the reference to entities occurs as the characteristic. In a specific embodiment, assigning step 840 spots and disambiguates references to the geographic names on the same page, or within a snippet of text in which the reference to entities occurs. In a specific embodiment, assigning step 840 uses the technique described in Amitay E., Har'El N., Sivan R., Soffer, A., Web-a-where: Geotagging Web Content, SIGIR 2004. In an exemplary embodiment, assigning step 840 operates on the page level or on the snippet level of the electronic document. In a specific embodiment, assigning step 810 includes assigning the geographic location associated with the portion of the electronic document in which the reference to entities occurs as the characteristic. In a specific embodiment, the assigning spots and disambiguates references to the geographic names on the same page, or within a snippet of text in which the reference to entities occurs. In another embodiment, the assigning assigns a geographic “focus” to each document. In a specific embodiment, the assigning uses the technique described in Amitay E., Har'El N., Sivan R., Soffer, A., Web-a-where: Geotagging Web Content, SIGIR 2004. In an exemplary embodiment, the assigning operates on the page level or on the snippet level of the electronic document.

Referring next to FIG. 8E, in a specific embodiment, assigning step 810 includes a step 850 of assigning the language of the snippet of text in which the reference to entities occurs as the characteristic. In a specific embodiment, assigning step 850 operates on the page level or on the snippet level of the electronic document.

Referring next to FIG. 8F, in a specific embodiment, assigning step 810 includes a step 860 of assigning the sentiment of the snippet of text in which the reference to entities occurs as the characteristic. In a specific embodiment, assigning step 860 uses the method described in J. Yi, T. Nasukawa, R. Bunescu, W. Niblack, Sentiment Analyzer: Extracting Sentiments about a Given Topic using Natural Language Processing Techniques, ICDE 2003. In an exemplary embodiment, assigning step 860 operates on the snippet level of the electronic document.

Referring next to FIG. 8G, in a specific embodiment, assigning step 810 includes a step 870 of assigning the author of the electronic document in which the reference to entities occurs as the characteristic.

Referring next to FIG. 8H, in a specific embodiment, assigning step 810 includes a step 880 of assigning the rank of the electronic document in which the reference to entities occurs as the characteristic, where the rank is selected from the group consisting of pagerank, hostrank, and eyeball count. In a specific embodiment, assigning step 810 includes assigning the pagerank of the electronic document in which the reference to entities occurs as the characteristic. In a specific embodiment, assigning step 810 includes assigning the hostrank of the electronic document in which the reference to entities occurs as the characteristic. In a specific embodiment, assigning step 810 includes assigning the eyeball count of the electronic document in which the reference to entities occurs as the characteristic.

Storing the Extracted Information

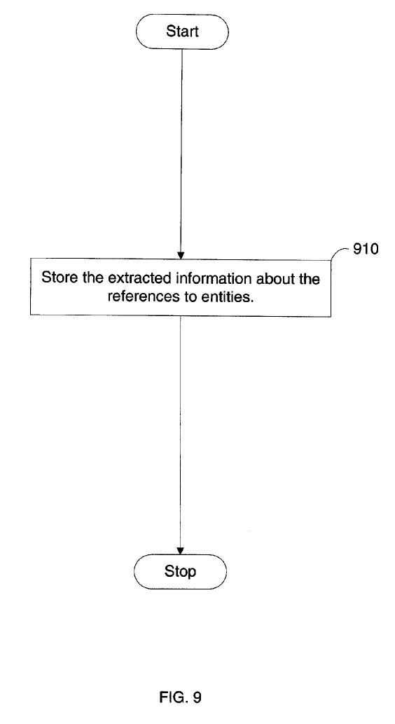

Referring to FIG. 9, in a further embodiment, the method and system further include a step 910 of storing the extracted information about the references to entities. In a specific embodiment, storing step 910 includes storing the extracted information in a repository that allows the extracted information to be manipulated. In a specific embodiment, the repository allows the extracted information to be manipulated in at least any of the following ways:

1. accessed;

2. queried;

3. counted;

4. ranked;

5. summarized;

6. presented;

7. analyzed; and

8. trended; and

9. used to send alerts.

In a specific embodiment, the repository allows the extracted information to be further queried (i.e., drilled-down to further detail). In a specific embodiment, the repository allows the extracted information to be analyzed via business analysis techniques. In a specific embodiment, storing step 910 stores the information in a database similar to an OLAP (Online Analytical Processing) cube. In a specific embodiment, the repository includes a computer database.

This allows trending, associations, ranking, and displays of “buzz” (i.e., measures of what customers are saying or feeling about a company or its products, breakdowns by time, demographics, and geography, strengths and weaknesses). As an example, source categorization combined with topic identification provides significant context and meaning to the data. For example, references to oil refinery byproducts on pages of an oil-industry research site are likely to have a completely different context and meaning when they appear on the website of an environmental Non-Governmental Organization (NGO), or in the Congressional Record. These novel occurrences are also cause for close scrutiny, even if they occur on lightly visited sites.

In an exemplary embodiment, storing step 910 stores the associated date and the metadata of each document in a persistent repository so that a new, updated version of a document with modified content and a new date is treated as a different document. Therefore storing step 910 maintains the history of each document in order to enable trending. When presenting trending data, the number of mentions or the number of pages associated with the entities is displayed. Optionally the number of pages or mentions is weighted by pagerank, hostrank, or “eyeball” count.

Allowing for the Input of Feedback

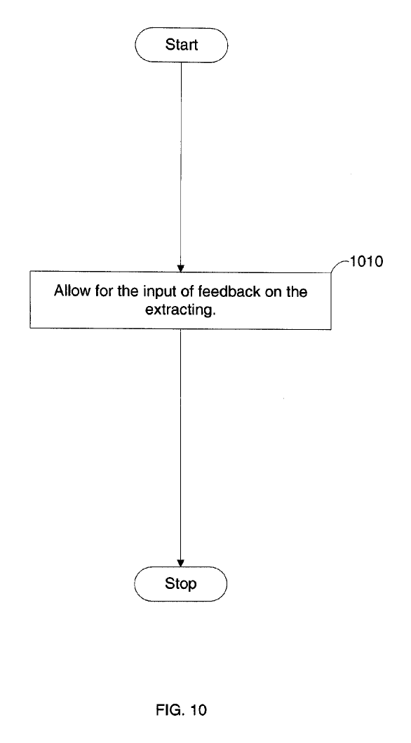

Referring to FIG. 10, in a further embodiment, the method and system further include a step 1010 of allowing for the input of feedback on the extracting. Allowing step 1010 displays the end results of the extracting in order to allow for the input of feedback at various stages of the process in order to improve the quality of the extracting (e.g., entity identification, issue definitions, sentiment evaluation, geographic spotting, source or site categorization). Allowing step 1010 allows real-time feedback that displays typically ranked results to allow for the refining of the input documents. Examples of data that can be modified for feedback include the following:

1. Additions, deletions, or modifications to the list of specific sources which are considered low quality and should be eliminated;

2. Additions, deletions, or modifications to the set of entity names, synonyms, abbreviations, and alternate spellings;

3. Additions, deletions, or modifications to the set of on- and off-topic terms used to disambiguate references to entities;

4. Additions, deletions, or modifications to the positive and negative terms used in sentiment evaluation;

5. Additions, deletions, or modifications to “stop words” or “uninteresting words” used in computing step 240;

6. Additions, deletions, or modifications to the topic terms used in computing step 240; and

7. Additions, deletions, or modifications to the geographic names and source categories used in characterizing step 260.

### CONCLUSION

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

What is claimed is:

1. A method of extracting information about references to entities from a plurality of electronic documents, the method comprising:
applying at least one document quality measure to each of the plurality of electronic documents;
recognizing the references to entities in the plurality of electronic documents;
using at least one reference quality measure for each of the references to entities;
computing at least one topical category associated with each of the references to entities;
finding at least one co-occurring term associated with each of the references to entities; and
characterizing each of the references to entities by at least one characteristic category.

2. The method of claim 1 wherein the applying comprises assigning at least one quality score to each of the plurality of electronic documents.

3. The method of claim 2 wherein the assigning comprises assigning the quality score based on the source of the electronic document.

4. The method of claim 2 wherein the assigning comprises assigning the quality score based on the amount of text in the electronic document.

5. The method of claim 2 wherein the assigning comprises assigning the quality score based on whether the electronic document is a duplicate of other electronic documents in the plurality of electronic documents.

6. The method of claim 2 wherein the assigning comprises assigning the quality score based on whether the electronic document is a near duplicate of other electronic documents in the plurality of electronic documents.

7. The method of claim 2 wherein the assigning comprises assigning the quality score based on whether the electronic document contains unwanted text.

8. The method of claim 2 wherein the assigning comprises assigning the quality score based on the rank of the electronic document, wherein the rank is selected from the group consisting of pagerank, hostrank, and eyeball count.

9. The method of claim 2 further comprising, if the quality score of the electronic document is less than a threshold, eliminating the electronic document.

10. The method of claim 1 wherein the recognizing comprises identifying candidate references to entities in the plurality of electronic documents from a set of entity names.

11. The method of claim 10 wherein the identifying comprises identifying the candidate references to entities by an identifying technique, wherein the identifying technique is selected from the group consisting of direct spotting, index-based retrieval, and named entity recognition.

12. The method of claim 10 further comprising disambiguating the candidate references to entities, thereby identifying the references to entities.

13. The method of claim 1 wherein the using comprises assigning at least one quality score to each of the references to entities.

14. The method of claim 13 wherein the assigning comprises assigning the quality score based on whether the snippet of text in which the reference to entities occurs is unique.

15. The method of claim 13 wherein the assigning comprises assigning the quality score based on the running text quality of the reference to entities.

16. The method of claim 13 wherein the assigning comprises assigning the quality score based on whether the snippet of text in which the reference to entities occurs can be parsed by natural language parsing to yield a subject and a verb.

17. The method of claim 13 wherein the assigning comprises assigning the quality score based on whether the snippet of text in which the reference to entities occurs can be parsed by natural language parsing to yield a valid sentence.

18. The method of claim 13 wherein the assigning comprises assigning the quality score based on whether the snippet of text in which the reference to entities occurs satisfies a set of heuristic rules based on the textual properties of the snippet.

19. The method of claim 13 wherein the assigning comprises assigning the quality score based on the document markup properties of the snippet of text in which the reference to entities occurs.

20. The method of claim 13 wherein the assigning comprises assigning the quality score based on whether the snippet of text in which the reference to entities occurs comprises content text.

21. The method of claim 13 further comprising, if the quality score of the reference to entities is less than a threshold, eliminating the reference to entities.

22. The method of claim 1 wherein the computing comprises identifying specified words and phrases that co-occur with the references to entities.

23. The method of claim 1 wherein the finding comprises finding unspecified words or phrases that co-occur with the references to entities.

24. The method of claim 1 wherein the characterizing comprises assigning at least one characteristic to each of the references to entities.

25. The method of claim 24 wherein the assigning comprises assigning the date of the electronic document in which the reference to entities occurs as the characteristic.

26. The method of claim 24 wherein the assigning comprises assigning the source type of the electronic document in which the reference to entities occurs as the characteristic.

27. The method of claim 24 wherein the assigning comprises assigning the geographic location associated with the electronic document in which the reference to entities occurs as the characteristic.

28. The method of claim 24 wherein the assigning comprises assigning the language of the snippet of text in which the reference to entities occurs as the characteristic.

29. The method of claim 24 wherein the assigning comprises assigning the sentiment of the snippet of text in which the reference to entities occurs as the characteristic.

30. The method of claim 24 wherein the assigning comprises assigning the author of the snippet of text in which the reference to entities occurs as the characteristic.

31. The method of claim 24 wherein the assigning comprises assigning the rank of the electronic document in which the reference to entities occurs as the characteristic, wherein the rank is selected from the group consisting of pagerank, hostrank, and eyeball count.

32. The method of claim 1 further comprising storing the extracted information about the references to entities.

33. The method of claim 1 further comprising allowing for the input of feedback on the extracting.

34. A system of extracting information about references to entities from a plurality of electronic documents, the system comprising:
an applying module configured to apply at least one document quality measure to each of the plurality of electronic documents;
a recognizing module configured to recognize the references to entities in the plurality of electronic documents;
a using module configured to use at least one reference quality measure for each of the references to entities;
a computing module configured to compute at least one topical category associated with each of the references to entities;
a finding module configured to find at least one co-occurring term associated with each of the references to entities; and
a characterizing module configured to characterize each of the references to entities by at least one characteristic category.

35. A computer program product usable with a programmable computer having readable program code embodied therein of extracting information about references to entities from a plurality of electronic documents, the computer program product comprising:
computer readable code for applying at least one document quality measure to each of the plurality of electronic documents;
computer readable code for recognizing the references to entities in the plurality of electronic documents;
computer readable code for using at least one reference quality measure for each of the references to entities;
computer readable code for computing at least one topical category associated with each of the references to entities;
computer readable code for finding at least one co-occurring term associated with each of the references to entities; and
computer readable code for characterizing each of the references to entities by at least one characteristic category.
